(19) United States
(12) Patent Application Publication
(10) Pub. No.: US 2008/0163742 A1
(43) Pub. Date: Jul. 10, 2008

(54) Rainbow method for stringed instruments

(76) Inventor: Janet L. Oliver, Melrose, MA (US)

Correspondence Address: LAMBERT & ASSOCIATES, P.L.L.C., 92 STATE STREET, BOSTON, MA, 02109-2004, US

(21) Appl. No.: 11/651,347

(22) Filed: Jan. 9, 2007

(51) Int. Cl. G09B 15/00

(52) U.S. Cl. 84/470 R

(57) ABSTRACT

A method is disclosed to aid beginning students of stringed musical instruments learn to play sheet music through the use of colored notes, with a separate, identifiable color being assigned to each finger to be used on the fingerboard. This method will help students learn which finger to use as they play instrumental music. With this method, the position of the colored note on the staff gives a reasonably clear indication of which string to place the finger on. Accompanying graphics illustrate the names of the notes and placement of fingers on the strings. The method is mainly intended for use in the first position, but could be adapted to other hand positions. Colored dots or bands of self-adhering paper or tape can be applied to the fingerboard longitudinally to mark where fingers should be placed.

### BACKGROUND OF THE INVENTION

1. Field of Invention

The invention relates generally to the field of musical instruction, particularly the instruction of stringed instruments.

2. Description of the Related Art

In order to play stringed musical instruments, such as the violin, one must learn several complicated skills that must be simultaneously performed to properly play a stringed instrument. One must learn to read sheet music and decipher the various clutters on a sheet of music. In addition, one must learn to correlate the written notes to proper finger positioning on the fingerboard of the stringed musical instrument. Students of musical stringed instruments must be trained to use the proper finger or no fingers on the fingerboard to produce each note represented on the sheet of music. Students must be trained to recognize and perform the correlation between finger usage and written notes.

Learning this correlation of notes and finger usage is a time consuming and often frustrating process for beginning students. Many solutions have been developed that attempt to simplify teaching music on stringed instruments.

U.S. Pat. No. 4,559,861, Patty et al., discloses a device for musical instruction that contains a metallic base with printed grid. Magnetic markers may then be placed on various portions of this grid to indicate appropriate finger placements upon the instrument.

U.S. Pat. No. 5,920,023, Ravigni, et al., discloses an adhesive sheet that may be slipped between the strings and the fingerboard of a stringed instrument. This sheet may contain colors to indicate notes of a scale, particular chords or notes. U.S. Pat. No. 6,218,603, Coonce, also discloses an adhesive material that is attached to the fingerboard on a stringed instrument.

U.S. Pat. No. 6,288,315, Bennett, discloses a template that may be attached to the top of a base; the base including various scales and/or note combinations. The template may include windows and be utilized in slide-rule fashion.

U.S. Pat. No. 6,483,018, Mead, discloses a chart that details each finger location along the fingerboard of a stringed instrument.

U.S. Pat. No. 6,660,921, Deverich, and U.S. patent application Publication No. 2004/0099124, Deverich, disclose a method for teaching stringed instruments in which each string is assigned a different color. The sheet music is formatted to contain numbers above each note to indicate the appropriate finger for the note. The strength of the color (light or dark) indicates which hand position the string is to be played in. Shifting between hand positions is noted by the use of a colored dash at the point of the shift.

U.S. Pat. No. 6,987,220, Holcomb, discloses a method for graphically notating music by representing notes of a scale by different shapes to show how the fingers are moved, as well as colors for different notes, and lengths of shapes to illustrate their intended duration.

These previous solutions provided devices and methods to help students learn to read sheet music more easily (e.g. by using colored fingering numbers printed above the notes on sheet music). In addition, the prior art discloses a variety of devices to help students learn where to place their fingers on fingerboards. (e.g. by placing fingerboard charts, colored dots or other adhesive inserts onto the actual fingerboard).

These previous solutions do not help students easily comprehend the correlation between notes printed on sheet music and finger usage on a musical stringed instrument. The previous solutions, containing fingering numbers above the notes or the use of fingerboard inserts, require the student to look away from the sheet music or require a student to process two bits of information at the same time. In addition, as soon as the music becomes even a little complex, the musical sheets become very cluttered with information.

Colors have been used to indicate which string to play or to indicate the notes of the scale. However, the prior art does not disclose the use of colors to correlate the fingering position on the fingerboard with the note printed on the sheet music.

The subject invention provides a simple method for teaching students to correlate notes printed on sheet music with fingers to be used on the fingerboard of a stringed musical instrument. This method allows students to learn the proper finger for each note without moving their eyes away from the sheet music. This method will allow students to learn finger to note correlations faster. By using the disclosed method, notes can be recognized more readily because the colors are bright and attractive and easy to process, and the learner can look at the notes themselves, rather than having to look away from the notes to a number to process two bits of information simultaneously. The sheet music is less cluttered and more pleasing to the eye.

### BRIEF SUMMARY OF THE INVENTION

The subject invention is drawn to a method for teaching a student the correct finger to use on a fingerboard of a stringed instrument to form a given note comprising a) assigning a first separate, distinct color for a first finger position on the fingerboard of the stringed instrument; b) assigning a second separate, distinct color for a second finger position on the fingerboard of the stringed instrument; c) assigning a third separate, distinct color for a third finger position on the fingerboard of the stringed instrument; d) assigning a fourth separate, distinct color for both the open finger position and a fourth finger position on the fingerboard of the stringed instrument; e) coloring notes on a musical staff with the first, second, third or fourth separate, distinct color for the correct finger to be used on the fingerboard to play each said note; wherein said first and third separate, distinct colors correspond to notes located on the leger lines of the musical staff; and further wherein said second and fourth separate, distinct colors correspond to notes located on the spaces of the musical staff.

These together with other objects of the invention, along with the various features of novelty which characterize the invention, are pointed out with particularity in the claims annexed to and forming a part of this disclosure. The invention is not limited to the embodiments described herein; thus, reference should be made to the accompanying drawings and descriptive matter in which the preferred embodiments of the invention are illustrated.

### BRIEF DESCRIPTION OF THE SEVERAL VIEWS OF THE DRAWINGS

FIG. 1 illustrates a musical staff of four sets of four consecutive notes all printed in the same distinct color since they are all played on open strings (or with no fingers on the fingerboard), wherein every other space on the staff correlates with an open string, and this relative position of the notes on the staff indicates which string to play.

FIG. 1B illustrates a musical staff of four sets of four consecutive notes all printed in the same distinct color, which is the same color as the notes in FIG. 1, wherein a number 4 is placed above certain notes to indicate that these notes are to be played with the fourth finger, while a note without the number 4 above it indicates that these notes are to be played on the open string. (In the first hand position, the highest notes of the staff can only be played with the fourth finger on the top string.)

FIG. 2 illustrates a musical staff with four sets of four consecutive notes wherein each set of notes is printed in a separate, distinct color to indicate the fingering position of the set of notes on the fingerboard of a stringed instrument. The relative position of each note on the staff indicates which string to play or place the finger on. The accompanying graphics illustrate placement of the fingers on the strings on the fingerboard, wherein the color of the lines and dots corresponds to the color of the notes on the staff.

FIG. 3 illustrates a musical staff with four sets of four consecutive notes wherein each alternating note on the spaces of the staff is printed in a separate, distinct color to indicate the fingering position of the note on the fingerboard of a stringed instrument. The relative position of the note on the staff indicates which string to play or which string to place the finger on. The accompanying graphic illustrates placement of the fingers on the strings on the fingerboard, wherein the color of the lines and dots corresponds to the color of the notes on the staff.

FIG. 4 illustrates a musical staff with four sets of four consecutive notes wherein each alternating note on the leger lines is printed in a separate, distinct color to indicate the fingering position of the note on the fingerboard of a stringed instrument. The relative position of the notes on the staff indicates which string to place the finger on. The accompanying graphic illustrates placement of the fingers on the strings on the fingerboard, wherein the color of the lines and dots corresponds to the color of the notes on the staff.

FIG. 5 illustrates the notes on a stringed instrument beginning with the note on the open string on the bottom string and ending with the note played with the third finger on the top string. The color of the note correlates with the finger to be used to play the note, while the relative position of the note on the staff indicates which string to play. The accompanying graphic illustrates placement of the fingers on the strings on the fingerboard, wherein the color of the lines and dots on the graphic correspond to the color of the notes on the staff.

FIGS. 6-8 illustrate musical compositions wherein the notes are printed in any one of four separate, distinct colors to indicate the fingering position of the note on the fingerboard of a stringed instrument. The relative position of the note on the musical staff indicates which string is to be played or the finger is to be placed on. The accompanying graphic illustrates placement of the fingers on the strings on the fingerboard, wherein the color of the lines and dots on the graphic correspond to the color of the notes on the staff.

FIG. 9 illustrates a musical composition wherein some of the notes are printed in any one of four separate, distinct colors to indicate the fingering position of the note on the fingerboard of a stringed instrument, while other notes are printed in black to help the student make the transition to reading traditional music in which the notes are all printed in black.

### DETAILED DESCRIPTION OF THE INVENTION

The subject invention is drawn to a method for teaching a student the correct finger to use on a fingerboard of a stringed instrument to form a given note comprising a) assigning a first separate, distinct color for a first finger position on the fingerboard of the stringed instrument; b) assigning a second separate, distinct color for a second finger position on the fingerboard of the stringed instrument; c) assigning a third separate, distinct color for a third finger position on the fingerboard of the stringed instrument; d) assigning a fourth separate, distinct color for both the open finger position and a fourth finger position on the fingerboard of the stringed instrument; e) coloring notes on a musical staff with the first, second, third or fourth separate, distinct color for the correct finger to be used on the fingerboard to play each said note; wherein said first and third separate, distinct colors correspond to notes located on the leger lines of the musical staff; and further wherein said second and fourth separate, distinct colors correspond to notes located on the spaces of the musical staff.

In a preferred embodiment of this invention, the notes on a musical staff are colored using different colors to indicate which finger a student is to use to play each said note on the stringed instrument fingerboard. In this embodiment of the invention, notes played with the first finger on the fingerboard of a stringed instrument are colored green on the staff. In the first hand position, these green colored notes will be located on staff or leger lines. Notes played with the second finger on the fingerboard of a stringed instrument are colored blue on the staff. In the first hand position, these blue colored notes will be located on open spaces of the staff. Notes played with the third finger on the fingerboard of a stringed instrument are colored purple on the staff. In the first hand position, these purple colored notes will be located on staff or leger lines. Notes played with the fourth finger or with open strings on the fingerboard of a stringed instrument are colored red on the staff. In the first hand position, these red colored notes will be located on open spaces of the staff.

Thus, in this preferred embodiment of the present invention, notes played on open strings are printed in red; notes played with the first finger are printed in green; notes played with the second finger are printed in blue; notes played with the third finger are printed in purple; and notes played with the fourth finger are printed in red since it is the same note as the open string above it; however, a number “4” can be printed above each note printed in red to indicate the use of the fourth finger as opposed to the open string for that note.

Emphasis is also placed on patterns: in the first position, notes played on open strings or with the second finger always fall on spaces while notes played with the first and third fingers always fall on lines. This will give the student a tool for faster note recognition when making the transition to traditional notes printed in black.

In alternative embodiments of the subject invention, any series of distinguishable colors may be used to correlate the fingering positions with the printed notes. In preferred embodiments, these colors will easily contrast with one another and the music sheet color to be easily identifiable by a user.

In other alternative embodiments of the subject invention, the same, distinct color would still be used for each fingering position; however, these distinct colors could be shaded more dark to indicate a high fingering position or shaded more lightly to indicate a low fingering position. For example, on the A string of a violin, the fingering position for the note B would be indicated by green, while the fingering position for the note B flat would be indicated by light green. In this embodiment, the notes B and B flat are both played with the same finger on the fingerboard (as indicated by the same color, i.e. green, for each printed note); however, the note of B flat would be colored more lightly to indicate that it is to be played with the same finger but at a lower position.

In another embodiment of the subject application, accompanying graphics illustrate placement of the fingers on the strings wherein colored lines and dots on the graphic correspond to the colors of the notes on the staff. Further, the colored lines and dots on the graphics can be labeled with the names of the notes to assist students with learning names of notes.

In another embodiment of the subject application, colored adhesive dots or tape corresponding to the first, second, third and fourth separate, distinct colors can be placed on the fingerboard of the stringed instrument to indicate where to place fingers.

In a further embodiment of the subject application, the stringed instrument may be selected from the group consisting of a cello, double bass, guitar, violin, electric bass, and a mandolin.

The preferred embodiment of the subject invention is intended for beginners, to be used with the first hand position on the fingerboard. However, in alternative embodiments of the subject invention, the method may be used with other hand positions by placing a marker above each printed note in which a hand shift occurs, e.g. 2nd, 3rd, and 4th. In this embodiment, while the colors will still continue to indicate which finger to use on the fingerboard, the notes will no longer follow the same pattern of lines and spaces.

In a further embodiment of the subject application, all of the colored notes can gradually be printed in the color black to help students make the transition to reading traditional music in which the notes are printed in black.

The subject invention encompasses pre-colored sheets of music that may be produced by using the disclosed method. This includes loose sheets of music, books of musical sheets, musical sheet kits for converting musical sheets, and any other packaged formats of musical sheets that are well known to those skilled in the art.

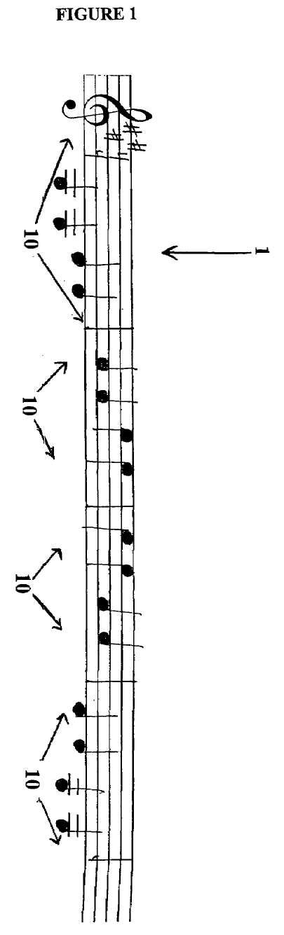

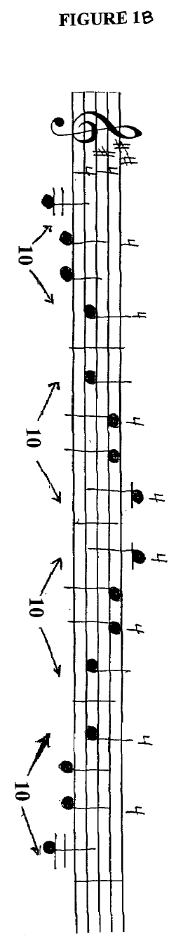

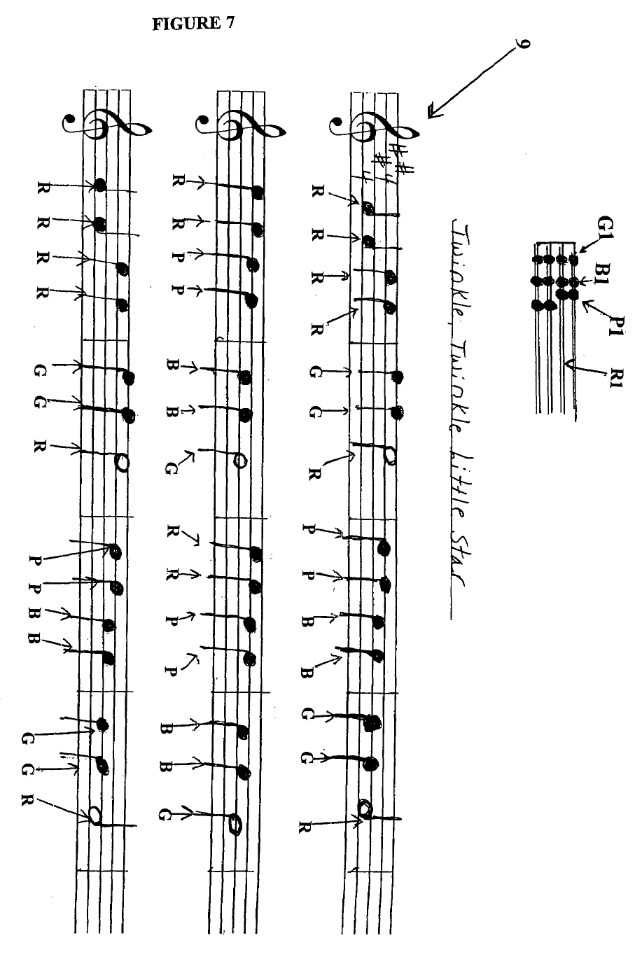

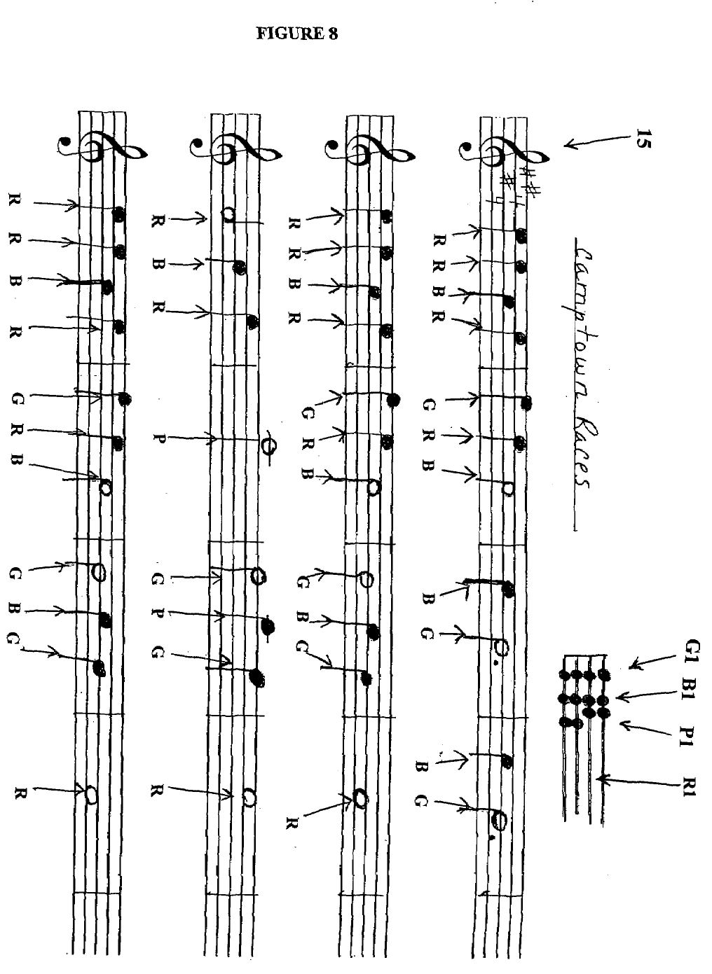

FIGS. 1-9 illustrate a preferred embodiment of the subject invention. In FIG. 1, musical staff 1 shows four sets of four consecutive notes 10 in the staff spaces which require the student to use the open position or no fingers on the fingerboard when played on the stringed musical instrument. The notes 10 are all printed in a distinguishable color. The relative position of the note on the staff indicates which string to play.

In FIG. 1B, musical staff 2 shows four sets of four consecutive notes 10 in the staff spaces which are printed in the same distinguishable color as the notes in staff 1 since they require the student to use the open string or no fingers on the fingerboard. A number 4 above certain notes indicates that these notes are to be played with the fourth finger on the string. (In the first hand position, the highest note can only be played with the fourth finger on the top string.)

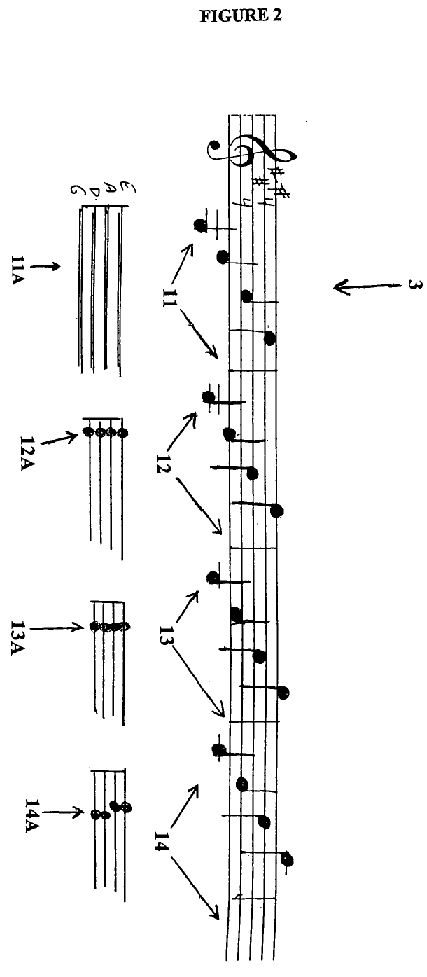

In FIG. 2, musical staff 3 shows four consecutive notes 11 in the staff spaces which require the student to use the open position or no fingers on the fingerboard when played on the stringed musical instrument. The notes 11 are all printed in a distinguishable color, a color that is the same color as the notes in 10. Musical staff 3 also shows four consecutive notes 12 on the staff lines which require the student to use the first finger on the fingerboard when played on the stringed musical instrument. The notes 12 are also all printed in a distinguishable color, a color that is different from the color of notes 10 and 11. Musical staff 3 also shows four consecutive notes 13 in the staff spaces which require the student to use the second finger on the fingerboard when played on the stringed musical instrument. The notes 13 are also printed in a distinguishable color, a color that is different from the color of notes 10, 11 and 12. Musical staff 3 further shows four consecutive notes 14 on the staff lines which require the student to use the third finger on the fingerboard when played on the stringed musical instrument. The notes 14 are also printed in a distinguishable color, a color that is different from the color of notes 10, 11, 12 and 13. The relative positions of the notes 11, 12, 13 and 14 indicate which string to play or place the finger on. The accompanying graphics illustrate the placement of the fingers on the strings, wherein the colors of the lines and dots on the graphics correspond to the colors of the notes on the staff. The lines 11A in the accompanying graphic are the same color as notes 11 and these lines 11A illustrate that these notes are played with no fingers or on open strings. The dots 12A in the accompanying graphic are the same color as notes 12 and these dots 12A illustrate the placement of the fingers on the strings for notes 12. The dots 13A in the accompanying graphic are the same color as notes 13 and these dots 13A illustrate the placement of the fingers on the strings for notes 13. The dots 14A in the accompanying graphic are the same color as notes 14 and these dots 14A illustrate the placement of the fingers on the strings for notes 14.

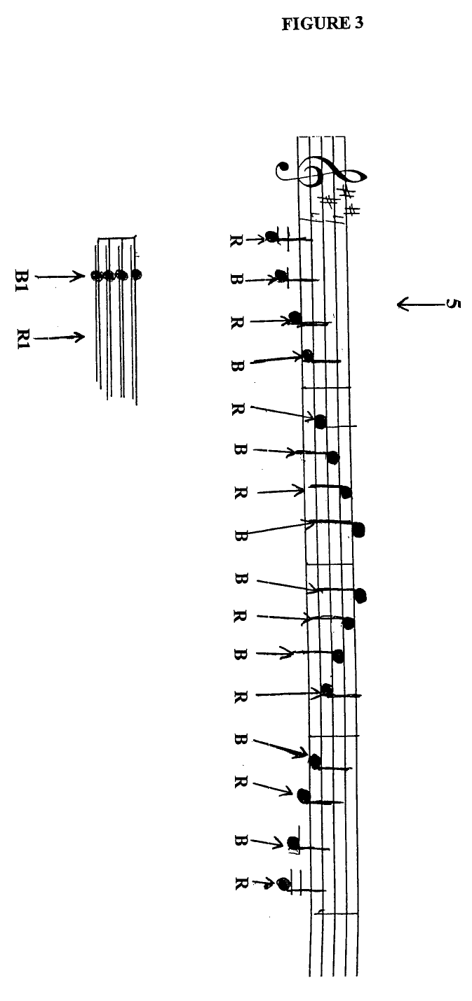

FIG. 3 illustrates musical staff 5 which is printed with a mixture of notes played with no fingers, all labeled R, and notes played with the second finger, all labeled B. All notes R and B are located in the staff open spaces. All the notes labeled R are printed in a distinguishable color, a color that is the same as notes 10 and 11, but a different color from notes 12, 13, and 14. All the notes labeled B are printed in a distinguishable color, a color that is the same as notes 13, but a different color from notes 10, 11, 12 and 14. The lines R1 in the accompanying graphic are the same color as notes R and these lines R1 illustrate that these notes are played with no fingers or the open string. The dots B1 in the accompanying graphic are the same color as notes B and these dots B1 illustrate the placement of the fingers on the strings for notes B.

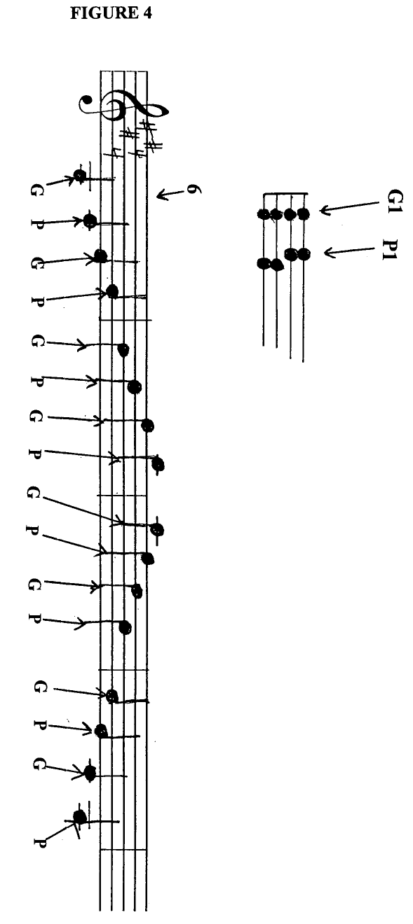

FIG. 4 illustrates musical staff 6 which is printed with a mixture of notes played with the first finger, all labeled G, and notes played with the third finger, all labeled P. All notes G and P are located on the staff lines. All the notes labeled G are printed in a distinguishable color, a color that is the same as notes 12, but a different color from notes 10, 11, 13, and 14. All the notes labeled P are printed in a distinguishable color, a color that is the same as notes 14, but a different color from notes 10, 11, 12, and 13. The dots G1 in the accompanying graphic are the same color as notes G and these dots G1 illustrate the placement of the fingers on the strings for notes G. The dots P1 in the accompanying graphic are the same color as notes P and these dots P1 illustrate the placement of the fingers on the strings for notes P.

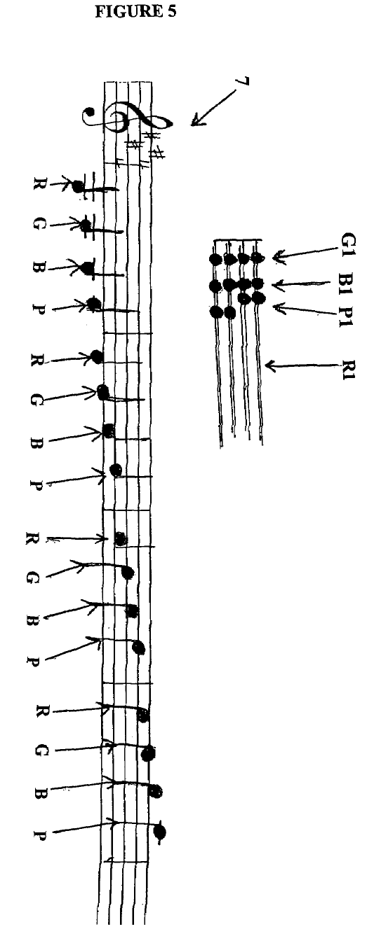

FIG. 5 illustrates musical staff 7 which is printed with the notes on a stringed instrument beginning with the open note on the bottom string and ending with the note played with the third finger on the top string. Notes played with no fingers are all labeled R, notes played with the first finger are all labeled G, notes played with the second finger are all labeled B, and notes played with a third finger are all labeled P. All notes R and B are located in the staff open spaces. All notes G and P are located on the staff lines. All the notes labeled R are printed in a distinguishable color, a color that is the same as notes 10 and 11, but a different color from notes 12, 13 and 14. All the notes labeled B are printed in a distinguishable color, a color that is the same as notes 13, but a different color from notes 10, 11, 12 and 14. All the notes labeled G are printed in a distinguishable color, a color that is the same as notes 12, but a different color from notes 10, 11, 13, and 14. All the notes labeled P are printed in a distinguishable color, a color that is the same as notes 14, but a different color from notes 10, 11, 12, and 13. The notes of musical staff 7 are colored as those illustrated in FIGS. 3 and 4. The relative position of the notes on the staff indicates which string to play or place the finger on. The accompanying graphic illustrates the placement of the fingers on the strings wherein the colors of the lines and dots on the graphics correspond to the colors of the notes on the staff. The lines R1 in the accompanying graphic are the same color as notes R and these lines R1 illustrate that these notes are played with no fingers or the open string. The dots B1 in the accompanying graphic are the same color as notes B and these dots B1 illustrate the placement of the fingers on the strings for notes B. The dots G1 in the accompanying graphic are the same color as notes G and these dots G1 illustrate the placement of the fingers on the strings for notes G. The dots P1 in the accompanying graphic are the same color as notes P and these dots P1 illustrate the placement of the fingers on the strings for notes P.

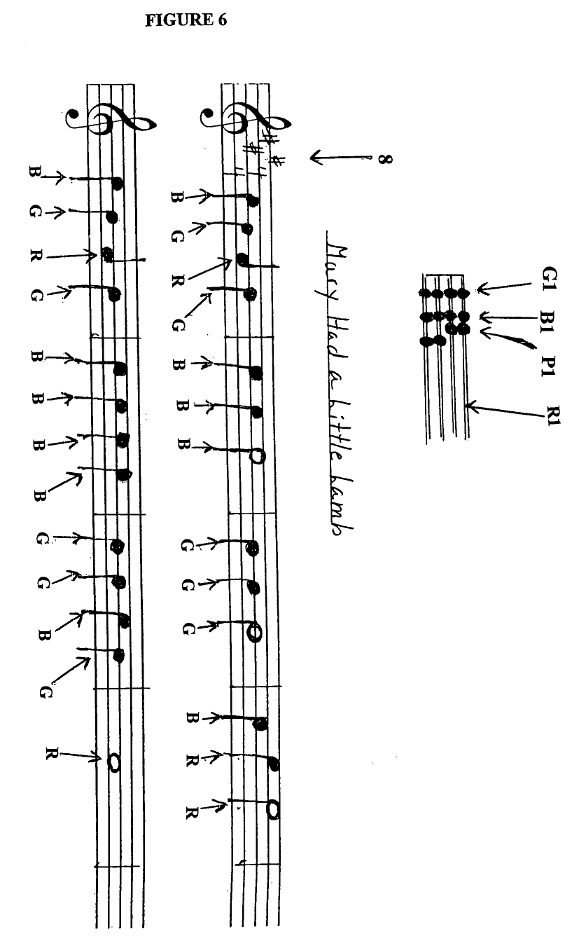

FIGS. 6-8 illustrate musical compositions 8, 9 and 15, which are each printed with a mixture of notes played with no fingers, all labeled R, notes played with the first finger, all labeled G, notes played with the second finger, all labeled B, and notes played with a third finger, all labeled P. All notes R and B are located in the staff open spaces. All notes G and P are located on the staff lines. All the notes labeled R are printed in a distinguishable color, a color that is the same as notes 10 and 11, but a different color from notes 12, 13 and 14. All the notes labeled B are printed in a distinguishable color, a color that is the same as notes 13, but a different color from notes 10, 11, 12 and 14. All the notes labeled G are printed in a distinguishable color, a color that is the same as notes 12, but a different color from notes 10, 11, 13, and 14. All the notes labeled P are printed in a distinguishable color, a color that is the same as notes 14, but a different color from notes 10, 11, 12, and 13. The notes of musical compositions 8, 9 and 15 are colored as those illustrated in FIGS. 3, 4 and 5. The relative position of the notes on the staff indicates which string to play or place the finger on. The accompanying graphics illustrate the placement of the fingers on the strings wherein the colors of the lines and dots on the graphics correspond to the colors of the notes on the staff. The lines R1 in the accompanying graphic are the same color as notes R and these lines R1 illustrate that these notes are played with no fingers or the open string. The dots B1 in the accompanying graphic are the same color as notes B and these dots B1 illustrate the placement of the fingers on the strings for notes B. The dots G1 in the accompanying graphic are the same color as notes G and these dots G1 illustrate the placement of the fingers on the strings for notes G. The dots P1 in the accompanying graphic are the same color as notes P and these dots P1 illustrate the placement of the fingers on the strings for notes P.

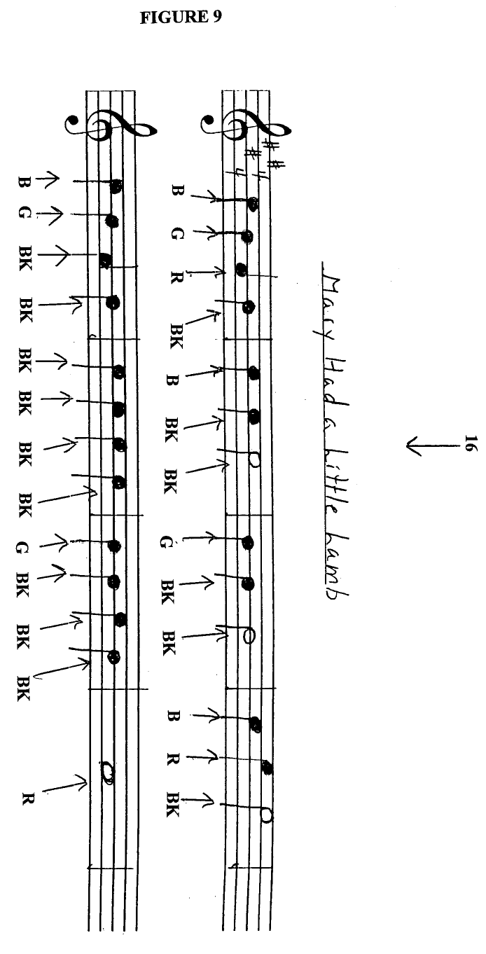

FIG. 9 illustrates musical composition 16 which illustrates a musical composition wherein some of the notes are printed in any one of four separate, distinct colors to indicate the fingering position of the note on the fingerboard of a stringed instrument and are labeled R, B, G or P as in FIGS. 3-8 above, while other notes that should be easily recognizable are printed in black BK to help the student make the transition to reading traditional music in which the notes are all printed in black.

I claim:

1. A method for teaching a student the correct finger to use on a fingerboard of a stringed instrument to form a given note comprising:
a) Assigning a first separate, distinct color for a first finger position on the fingerboard of the stringed instrument;
b) Assigning a second separate, distinct color for a second finger position on the fingerboard of the stringed instrument;
c) Assigning a third separate, distinct color for a third finger position on the fingerboard of the stringed instrument;
d) Assigning a fourth separate, distinct color for both the open finger position and a fourth finger position on the fingerboard of the stringed instrument; and
e) Coloring notes on a musical staff with the first, second, third or fourth separate, distinct color for the correct finger to be used on the fingerboard;
wherein said first and third separate, distinct colors correspond to notes located on the leger lines of the musical staff; and further wherein said second and fourth separate, distinct colors correspond to notes located on the spaces of the musical staff, further wherein the relative position of each said note on the musical staff indicates which string to place the finger on.

2. The method of claim 1, wherein the stringed instrument is selected from the group consisting of cello, double bass, guitar, violin, electric bass and mandolin.

3. A sheet of music created in accordance with the method of notating music of claim 1.

4. A music notation assembly kit comprising a plurality of sheets of music created in accordance with the method of notating music of claim 1.

5. A music notation assembly kit comprising a plurality of sheets of music created in accordance with the method of notating music of claim 1 and means for coloring all or a portion of an area or areas of the stringed instrument according to said method of notating music.

6. The method of claim 1, further comprising: step f) creating an accompanying graphic of the fingerboard of the stringed instrument wherein the first, second, third, fourth and open finger positions on the fingerboard are marked with an identifiable label.

7. The method of claim 1, wherein the identifiable label comprises colored lines and dots.

8. The method of claim 1, wherein the identifiable label comprises the names of the notes.

9. A book of music created in accordance with the method of notating music of claim 1.
